(19) United States
(12) Patent Application Publication
(10) Pub. No.: US 2015/0266212 A1
(43) Pub. Date: Sep. 24, 2015

(54) Cleansing Device and Method for Manufacturing Same

(71) Applicant: Bodhi Williams, Hampstead, MD (US)

(72) Inventor: Bodhi Williams, Hampstead, MD (US)

(21) Appl. No.: 14/219,060

(22) Filed: Mar. 19, 2014

(51) Int. Cl. B29C 39/10; B29C 39/36; C11D 17/04

(52) U.S. Cl. CPC B29C 39/10; C11D 17/046; B29C 39/36; B29K 2105/0058

(57) ABSTRACT

A novel cleansing device and method for manufacturing same is disclosed that provides for the combination of various soaps and detergents affixed to a cleansing pad that will not separate from the soap base and provides for enhanced lathering capabilities. A unique mold cavity having an internal support shelf is disclosed which improves the quality and ease of manufacturing the cleansing device.

### OVERVIEW OF INVENTION

### Purpose of Invention

The present invention is comprised of a combined exfoliating pad and soap device, as well as methods for manufacturing the same. The incorporation of soap base with an exfoliating pad provides an abrasive quality superior to that available in conventional soap bars. The incorporation of soap base, water and air in the exfoliating pad produces a thick lather while requiring only one hand to operate. The method of manufacture comprises the use of a unique mold cavity geometry that allows for the improved attachment of the exfoliating pad to the soap base.

### Description of Problem(s) Solved by Invention

With pre-existing products, the exfoliating pad is required to be held in one hand while liquid soap is applied with the other hand. The liquid soap is easily diluted with water and much of the product is immediately wasted down the drain. The incorporation of a solid soap bar with the exfoliating pad facilitates the complete usage of the soap with no waste or leftover un-used portions.

While previous combinations of a soap bar with a wash cloth or sponge appear to have been attempted, such a combination has been shown to decrease the serviceability and lifespan of the product when stored in moist environments due to the soap bar melting into a semi-solid or liquid form In contrast, the present invention retains water and lather during use, but sheds water when placed in a downward position after use. Other pre-existing products have surrounded and encapsulated a scrubbing element with soap material to form a bar, thus not allowing the abrasive or lather producing qualities to be available until a substantial portion of the product has been worn away; reducing the serviceability and lifespan of the product. In contrast, the present invention molds the majority of the exfoliating pad outside of the soapbase, facilitating the abrasive and lathering properties immediately and throughout the lifespan of the product.

In addition to these problems, is the natural tendency for the exfoliating pad to separate from the soap base as the soap base is softened by the introduction of water to both the exfoliating pad and the soap base. Other pre-existing products have attempted to combine a scrubbing element with a soap bar by means of a cement, glue or adhesive layer, making the product vulnerable to delamination, while adding a step to the manufacturing process. In contrast, the present invention molds the exfoliating pad directly and permanently to the soap base in a single step process, by infiltrating the airspaces between the fibers of the exfoliating pad with the liquefied soapbase prior to solidifying through the use of a unique mold cavity geometry, which incorporates a support shelf in the mold cavity. The support shelf extends into the mold cavity to create a predetermined position for the exfoliating pad to rest on while the liquefied soapbase hardens. In order for the support shelf feature to disengage from the hardened soapbase, the mold must be made from a pliable material such as silicone or some other appropriate elastomer.

### DESCRIPTION OF DRAWINGS OF INVENTION

The Applicant has attached the following figures of the invention at the end of this patent application:

FIG. 1 is an isometric view of a cleansing device in accordance with an embodiment of the invention;

FIGS. 2a, 2b and 2c are plan views of the various components of the cleansing device in accordance with an embodiment of the invention;

FIG. 3a is an isometric view of a mold cavity in accordance with an embodiment of the invention;

FIG. 3b is a top plan view of a mold cavity in accordance with an embodiment of the invention;

FIG. 3c is a side plan view of a mold cavity in accordance with an embodiment of the invention; and,

FIGS. 4a, 4b and 4c are a series of figures illustrating a first method of manufacturing one embodiment of the invention.

### DETAILED DESCRIPTION OF INVENTION

### Overview

The present invention is a cleansing device which is generally comprised of an exfoliating pad which is fixedly secured to a solidified soap or detergent base, as well as the method for manufacturing the cleansing device. Exemplary illustrations of the present invention are shown in the appended figures. By blending different additives in the soap or detergent base and varying the textures and abrasive properties of the exfoliating pad, the present invention may be utilized in a variety of industries, including without limitation, shower soap, shaving soap, facial soap, cellulite reduction, acne treatment, callus removal for palms and heels, caffeine for transdermal absorption, mechanics soap with added grease cutters, kitchen cleaning, dish washing, laundry, pet bathing, camping, fishing, marine, boating and watercraft, automotive, leather and upholstery, chrome wheel cleaning, charcoal grill cleaning and the like.

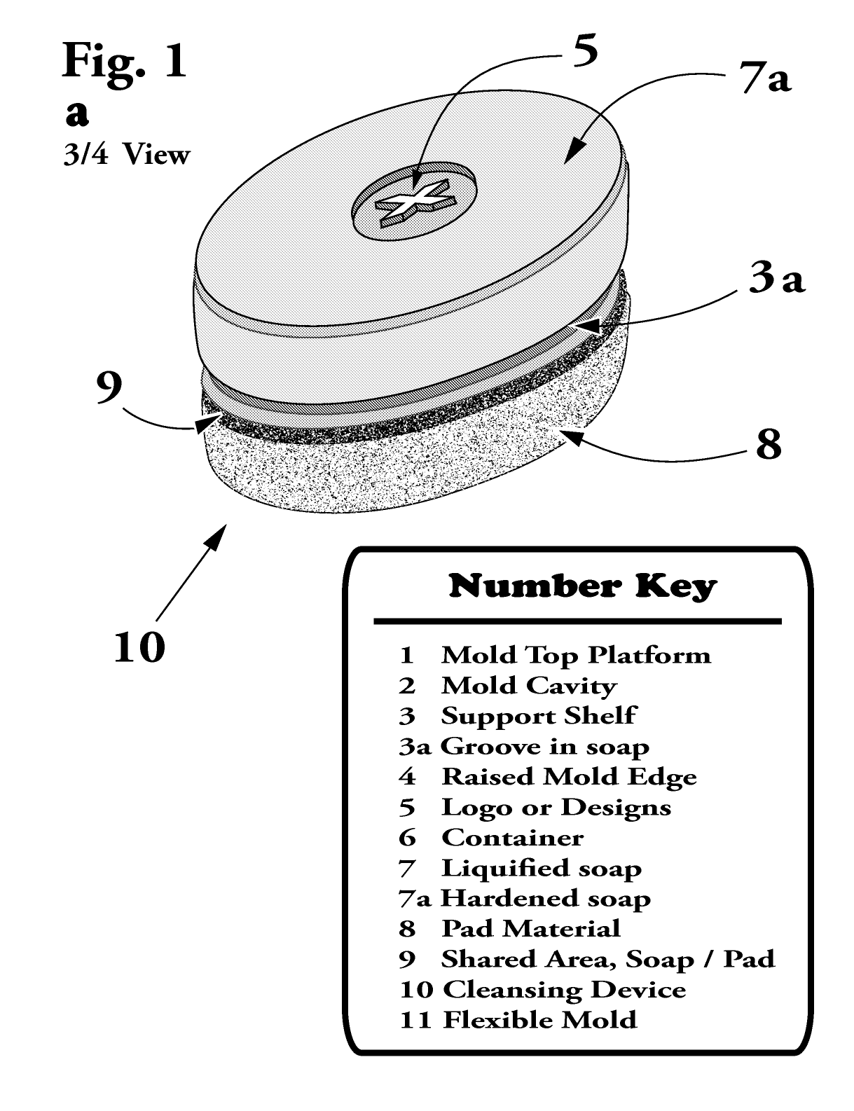

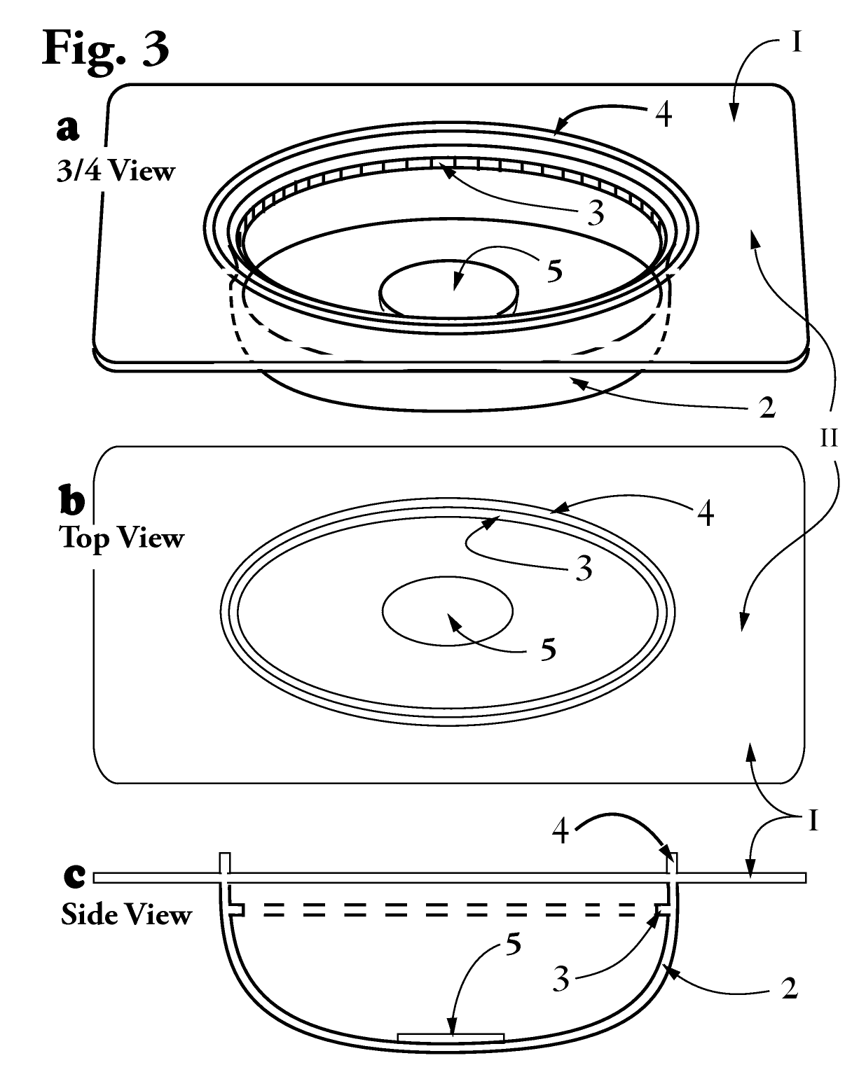

FIG. 1 illustrates an embodiment 10 of the present invention, which may be comprised of an oblong shaped exfoliating pad 8, which may be fixedly secured and molded to a similarly shaped solidified soap base 7a. A thin region 9, located between the pad 8 and soap base 7a, is where the liquefied soap base was allowed to infuse and embed into the pad 8 is provided. The entrapment of the soap base 7a in between the fibers of the material that comprises the exfoliating pad 8 is what secures the pad 8 to the soap base 7a. A groove 3a runs along the periphery of the cleansing device 10 and is formed by an inwardly extending support shelf 3 (see FIG. 3c) that may be formed in a mold side wall 2. A logo or design area 5 may be provided on the surface of the soap base for marketing or visual design enhancements to the product.

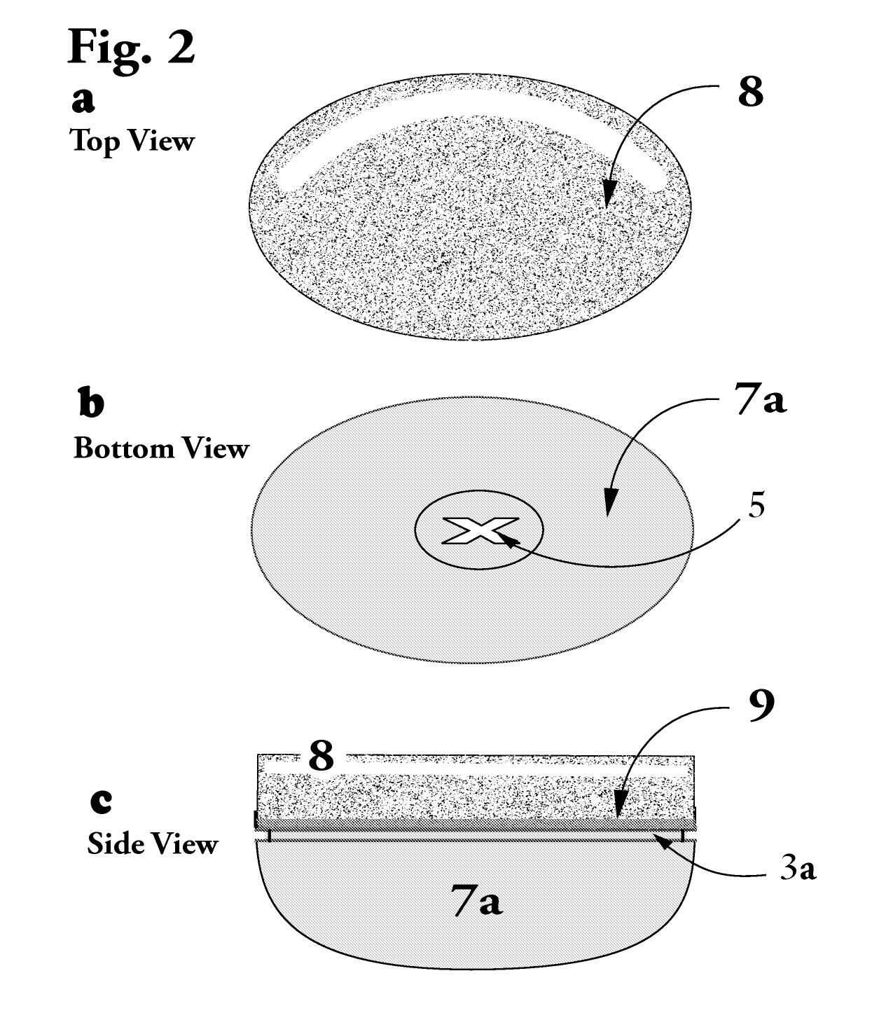

FIG. 2a shows a top plan view of the exfoliating pad 8 in accordance with an embodiment of the invention. The exfoliating pad may be comprised of various materials which allow water to be held in the airspaces between fibers of the pad, but do not absorb water into the fibers themselves and hold it in suspension. Further, the liquefied soap base 7, will mold between these airspaces and surround the fibers, bonding the exfoliating pad securely to the cleansing device. The exfoliating pad may be comprised of natural materials and/or woven, non-woven, extruded polymers and/or other man-made materials. Various configurations, materials, sizes, shapes and textures may be utilized for the exfoliating pad of the present invention. It is appreciated that various other configurations, materials, sizes, shapes and textures which are not shown in the figures may be utilized, and thus the scope of the present invention should not be limited to the exemplary illustrations of the exfoliating pads included herewith.

FIG. 2b shows a top plan view of the hardened soap 7a with the logo area 5 molded into the surface of the hardened soap 7a. The present invention will generally utilize soaps, true soaps, glycerin soaps, melt and pour soaps, saponified soaps, detergent soaps and/or surfactants of various types of cleaning compositions that will produce lather when combined with water. However, it is appreciated that various types of cleansing compositions may be utilized with the present invention and thus its scope should not be construed as being limited specifically to soaps. As used herein, the term soap base should be construed as encompassing any cleaning composition, including soaps and detergents, which are capable of transitioning from a liquefied state to a solidified state within the molding case of the present invention. For example, the soap base of the present invention could in some embodiments be comprised of hot processed soaps, cold process/saponified detergents (such as those which utilize lye in the hardening process) and other similar compositions.

FIG. 2c. shows a side plan view of the cleansing device 10 with the exfoliating pad 8 affixed to the hardened soap 7a. As can easily be seen, the region 9 is established at a predetermined location based on the amount of soap base is allowed to infiltrate and infuse into the exfoliating pad 8.

Referring now to FIGS. 3a, 3b and 3c, which shows a flexible mold for the manufacture of the cleansing device 10 in accordance with an embodiment of the invention. A flexible mold 11 is comprised of a mold cavity 2 wherein the mold cavity is shaped and formed to hold the liquefied soap base during the manufacturing process. It is appreciated that the flexible mold 11 may be comprised of various materials, configurations, sizes, shapes and number of cavities to suit different applications and may be re-used for continuous production or may also be used as the packaging of the cleansing device. Thus, the exemplary configurations, sizes, shapes and number of cavities of the molding cases illustrated in the figures hereto should not be construed as limiting on the scope of the present invention.

A support shelf 3 protrudes inwardly from the mold cavity 2 at a predetermined position wherein the support shelf 3 is configured to engage and support the bottom surface of the exfoliating pad 8 when the exfoliating pad 8 is placed into the liquefied soap base 7. The location of the support shelf 3 determines and controls the precise amount of liquefied soap that is allowed to infuse into the exfoliating pad 8, but more importantly, provides a quick and easy controlled means to ensure that this feature is repeatable during the manufacturing process. Being able to quickly and easily drop the exfoliating pad 8 into the mold cavity 2 and ensure the size of the thin region 9 is maintained enhances the quality and functionality of the cleansing device 10.

A raised mold edge 4 may be provided adjacent the mold cavity 2 in order to further control the placement of the exfoliating pad 8 into the mold cavity 2.

As mentioned previously, the mold cavity 2 may be made from a pliable material such as silicone or the like. A pliable material is required in order to be able to remove the support shelf 3 from the hardened soap 7a in order to de-mold the finished cleansing device 10 from the mold cavity 2.

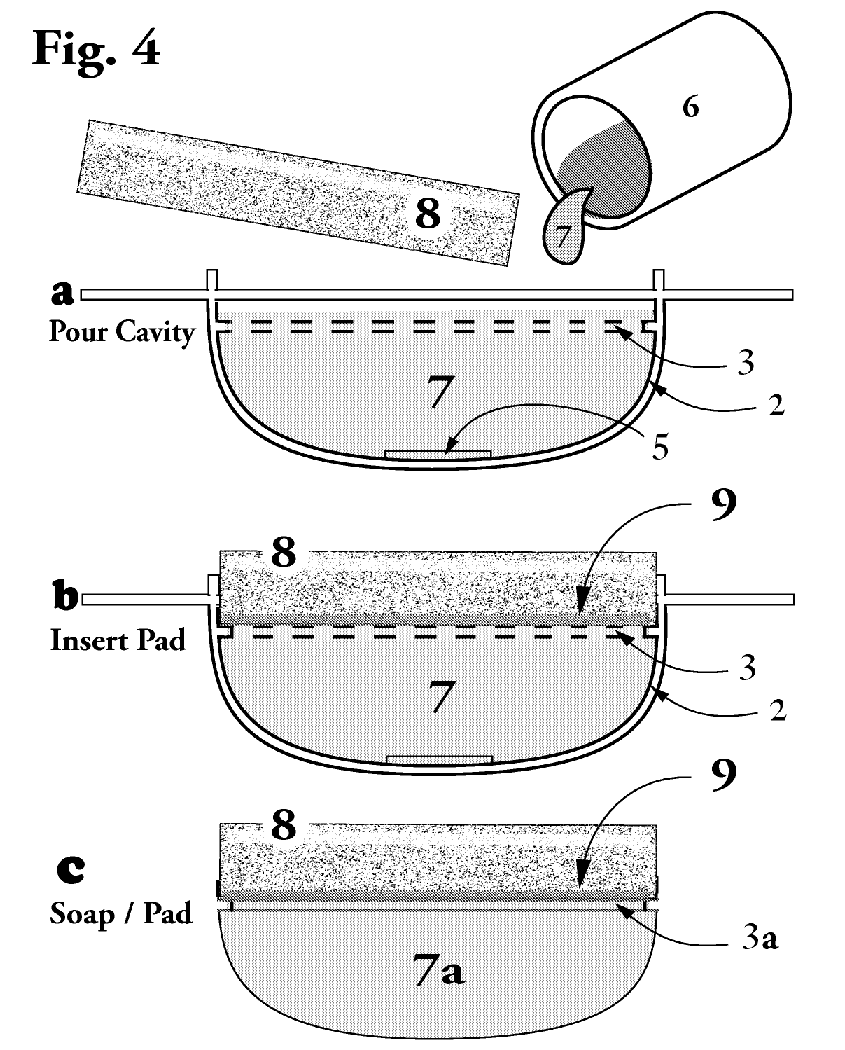

Referring now to FIGS. 4a, 4b and 4c which shows the manufacturing process in accordance with an embodiment of the invention. The liquid and/or liquefied (when heated) soap base 7 is first mixed with other ingredients and then poured into mold cavity 2, the exfoliating pad 8 is then introduced into the liquid and the soap base is allowed to cool at room temperature or quick chilled in a refrigeration/cooling device, until hardened. It is appreciated that the composition of the soap base may vary for different applications. By way of illustration and without limitation, the soap base may be formulated using any or all of a variety of materials such as aloe vera, soy bean, castile, cocoa, olive oil, hemp seed, peach kernel, soap nuts, carrier oils or the like. The soap base may also contain chemical ingredients such as sodium laureth sulfate, propylene glycol, sodium stearate, sorbitol, steric acid, lauric acid, sodium chloride, sodium hydroxide, myristic acid and the like. Additives may also be incorporated into the soap base, such as glycerin, goat milk, honey, shea butter, cocoa butter, Vitamin E, arabica oil, herbs, caffeine, salicylic acid, artificial fragrances, wetting agents, foaming agents, surfactants, essential oils, natural or synthetic colorants. Substrates may also be provided to be mixed in and/or dusted upon the bar including oatmeal, walnut shells, coffee grounds, lavender buds, lemon peel, cocoa powder, clays, micas, silicas, etc.

The heated and or liquified soap base 7, will preferably be incorporated and infused into the airspaces between the fibers of the exfoliating pad 8 and when cooled and/or solidified will integrate and affix the exfoliating pad 8 and the hardened soap 7a together.

The liquefied soap base 7 is poured from the mixing container 6 into the mold cavity 2 to the desired level which is just above the support shelf 3. The exfoliating pad 8 may then be placed into the upper opening of the mold cavity 2, such that a desired portion 9, of the exfoliating pad 8 may be immersed within the liquefied soap base 7. The liquefied soap base 7 will integrate into the airspaces between the fibers of the exfoliating pad 8 and when cooled and/or solidified will fasten the exfoliating pad 8 and the hardened soap base 7a together.

In use, the cleansing device 10 is held in the hand and placed into a water source. By rubbing the soap side of the cleansing device with water and rotating the bar three to five revolutions, a lather is produced. With each subsequent rotation, the lather is pushed by hand into the porous pad 8 to create a thicker lather with each pass. When the desired amount of lather is produced, the exfoliating pad 8 of the cleansing device 10 is rubbed against the skin or object to be cleansed to produce friction and deposit the lather. Unless otherwise defined, all technical and scientific terms used herein have the same meaning as commonly understood by one of ordinary skill in the art to which this invention belongs. Although methods and materials similar to or equivalent to those described herein can be used in the practice or testing of the present invention, suitable methods and materials are described above. All publications, patent applications, patents, and other references mentioned herein are incorporated by reference in their entirety to the extent allowed by applicable law and regulations. In case of conflict, the present specification, including definitions, will control. The present invention may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

1. A method for producing a cleansing device comprising the steps of:
providing a molding cavity, wherein said molding cavity comprises an internal mold volume,
providing a step in said molding case, said step defining an upwardly facing annular edge,
transferring a liquefied soap into said molding cavity such that the level of the liquefied soap is above said step; and,
placing an exfoliating pad in said molding cavity such that said liquefied soap engages around and fixedly attaches to said exfoliating pad.

2. The method of claim 1, wherein said exfoliating pad is comprised of material that does not absorb water such that said exfoliating pad will not separate from said soap base following the introduction of water to the cleansing device.

3. The method of claim 1, wherein said molding cavity is comprised of a pliable material.

4. The method of claim 3, wherein said pliable material is one selected from a group consisting of rubber and silicone.

5. The method of claim 1, further comprising the step of removing said cleansing device from said molding cavity by manually deforming said mold cavity and disengaging said cleansing device from said molding cavity.

6. The method of claim 1, wherein said soap base is comprised of one selected from the group consisting of shower soap, shaving soap, facial soap, cellulite reduction, acne treatment, callus removal, caffeine for transdermal absorption, and mechanics soap with added grease cutters.

7. The method of claim 1, wherein said exfoliating pad is a non-natural, synthetic material.

8. The method of claim 1, wherein said exfoliating pad Is comprised of a mesh bath puff.
